(19) United States
(12) Patent Application Publication
(10) Pub. No.: US 2005/0174560 A1
(43) Pub. Date: Aug. 11, 2005

(54) Multi-beam laser rangefinder

(76) Inventors: Amir Imber, Karmiel (IL); Chris Goshtchevsky, Michmanim (IL)

Correspondence Address: DR. MARK FRIEDMAN LTD.;C/o Bill Polkinghorn, 9003 Florin Way, Upper Marlboro, MD, 20772, US

(21) Appl. No.: 11/037,362

(22) Filed: Jan. 19, 2005

(30) Foreign Application Priority Data
Jan. 1, 2004 (IL) 159945

(51) Int. Cl. G01C 3/08; G01S 13/00

(52) U.S. Cl. 356/5.01; 356/4.01; 356/4.08

(57) ABSTRACT

A multi-beam rangefinder system for estimating a range-derived value of an airborne platform relative to the ground. A planar model approximates the ground. The system includes a transmitter arrangement to produce a number of pulses of electromagnetic radiation directed in three or more non-coplanar directions and a sensor arrangement for sensing the pulses of electromagnetic radiation reflected from the ground. The systems also includes a processor arrangement for processing independent measurement of time of flight of the pulses in each of the three or more non-coplanar directions, in order to estimate the range derived value of the airborne platform relative to the ground.

### FIELD AND BACKGROUND OF THE INVENTION

The present invention relates to a laser rangefinder and, in particular, it concerns a multi-beam laser rangefinder.

By way of introduction, pressure and radar driven measurement systems used for airborne platform guidance are generally inaccurate, especially at low altitudes where higher precision is needed.

Laser rangefinders are used to measure distances to near and distant objects by measuring the time taken for laser pulses to travel to and from a target. The direction of the laser beam greatly affects the measurement taken, as will now be explained. Reference is now made to FIG. 1, which is a schematic view of a single-beam rangefinder 10 that is constructed and operable in accordance with the prior art. Single-beam rangefinder 10 is disposed on an airborne platform 14. Due to the orientation of airborne platform 14, the line of sight 12 of single-beam rangefinder 10 is directed to point A on the surface of the ground below. Therefore, single-beam rangefinder 10 measures a distance a from single-beam rangefinder 10 to the ground. However, the height of single-beam rangefinder 10 above the ground is equal to b. Therefore, the altitude of airborne platform 14 is incorrectly measured. At low altitudes, for example, less than 500 meters altitude for auto pilot landing of a small aircraft or less than 50 meters altitude for operating an emergency system in case of an impending crash, the accuracy of altitude calculation is very important.

Reference is now made to FIG. 2, which is a schematic view of single-beam rangefinder 10 of FIG. 1 performing a measurement above sloped ground. In this scenario, line of sight 12 of single-beam rangefinder 10 is directed vertically downward. Nevertheless, the ground below airborne platform 14 is sloped. Therefore, the altitude calculation measured by single-beam rangefinder 10 gives a false measurement of the position of airborne platform 14 relative to the ground below. In addition, the altitude calculation cannot be used to calculate roll or pitch of airborne platform 14 relative to the ground nor the time-to-hit the ground by airborne platform 14 for automatic landing purposes.

There is therefore a need for an accurate altitude measurement and/or an accurate navigation system for use with an airborne platform.

### SUMMARY OF THE INVENTION

The present invention is a multi-beam rangefinder system and method of operation thereof.

According to the teachings of the present invention there is provided, a multi-beam rangefinder system for estimating a range-derived value of an airborne platform relative to the ground, the ground being approximated by a planar model, the system comprising: (a) a transmitter arrangement configured for producing a plurality of pulses of electromagnetic radiation directed in at least three non-coplanar directions; (b) a sensor arrangement for sensing the pulses of electromagnetic radiation reflected from the ground; and (c) a processor arrangement configured for processing of independent measurements of time of flight of the pulses in each of the three non-coplanar directions in order to estimate the range derived value of the airborne platform relative to the ground.

According to a further feature of the present invention, the transmitter arrangement is configured such that the pulses are produced as non-overlapping pulses.

According to a further feature of the present invention, the transmitter arrangement is configured for producing the pulses sequentially in the three non-coplanar directions.

According to a further feature of the present invention, the processor is configured for processing of independent measurements of time of flight of the pulses in each of the three non-coplanar directions in order to estimate an altitude of the airborne platform relative to the ground.

According to a further feature of the present invention, the processor is configured for processing of independent measurements of time of flight of the pulses in each of the three non-coplanar directions in order to estimate a rate of a descent or ascent of the airborne platform relative to the ground.

According to a further feature of the present invention, the processor is configured for processing of independent measurements of time of flight of the pulses in each of the three non-coplanar directions in order to estimate a rate of an acceleration of the airborne platform relative to the ground.

According to a further feature of the present invention, the processor is configured for processing of independent measurements of time of flight of the pulses in each of the three non-coplanar directions in order to estimate a time to hit the ground by the airborne platform.

According to a further feature of the present invention, the processor is configured for processing of independent measurements of time of flight of the pulses in each of the three non-coplanar directions in order to estimate a roll of the airborne platform relative to the ground.

According to a further feature of the present invention, the processor is configured for processing of independent measurements of time of flight of the pulses in each of the three non-coplanar directions in order to estimate a pitch of the airborne platform relative to the ground.

According to a further feature of the present invention, the processor is configured for processing of independent measurements of time of flight of the pulses in each of the three non-coplanar directions in order to estimate an angular velocity of the airborne platform relative to the ground.

According to a further feature of the present invention, the processor is configured for processing of independent measurements of time of flight of the pulses in each of the three non-coplanar directions in order to estimate an angular acceleration of the airborne platform relative to the ground.

According to a further feature of the present invention, the sensor arrangement includes a single detector, the sensor arrangement having a field of view which is wide enough, such that the single detector detects the pulses of all of the at least three non-coplanar directions.

According to a further feature of the present invention, there is also provided an emergency system configured for being actuated in response to the range derived value exceeding a predefined value.

According to a further feature of the present invention, the predefined value is a rate of a descent or ascent of the airborne platform relative to the ground.

According to a further feature of the present invention, the predefined value is a time to hit the ground by the airborne platform.

According to the teachings of the present invention there is also provided a method for estimating a range-derived value of an airborne platform relative to the ground, the ground being approximated by a planar model, the method comprising the steps of: (a) producing a plurality of pulses of electromagnetic radiation directed in three non-coplanar directions; (b) receiving the pulses of electromagnetic radiation reflected from the ground; and (c) processing independent measurements of time of flight of the pulses in each of the three non-coplanar directions in order to estimate the range derived value of the airborne platform relative to the ground.

According to a further feature of the present invention, the range defined value is a rate of a descent or ascent of the airborne platform relative to the ground.

According to a further feature of the present invention, the range defined value is a time to hit the ground by the airborne platform.

According to a further feature of the present invention, the range defined value is a roll of the airborne platform relative to the ground.

According to a further feature of the present invention, the range defined value is a pitch of the airborne platform relative to the ground.

According to a further feature of the present invention, the range defined value is an angular velocity of the airborne platform relative to the ground.

According to a further feature of the present invention, the range defined value is an angular acceleration of the airborne platform relative to the ground.

According to a further feature of the present invention, the range defined value is a rate of a descent or ascent of the airborne platform relative to the ground.

According to a further feature of the present invention, the range defined value is an acceleration of the airborne platform relative to the ground.

According to a further feature of the present invention, the step of producing is performed by producing the pulses as non-overlapping pulses directed in three non-coplanar directions.

According to a further feature of the present invention, the step of producing is performed by producing the pulses sequentially in the three non-coplanar directions.

According to a further feature of the present invention, there is also provided the step of actuating an emergency system in response to the range derived value exceeding a predefined value.

According to a further feature of the present invention, the predefined value is a rate of a descent or ascent of the airborne platform relative to the ground.

According to a further feature of the present invention, the predefined value is a time to hit the ground by the airborne platform.

### BRIEF DESCRIPTION OF THE DRAWINGS

The invention is herein described, by way of example only, with reference to the accompanying drawings, wherein:

FIG. 1 is a schematic view of a single-beam rangefinder that is constructed and operable in accordance with the prior art;

FIG. 2 is a schematic view of the single beam rangefinder of FIG. 1 performing a measurement above sloped ground;

FIG. 3 is a schematic view of a multi-beam laser rangefinder system performing measurements that is constructed and operable in accordance with a preferred embodiment of the invention;

FIG. 4 is a schematic block view of the multi-beam laser rangefinder system of FIG. 3;

FIG. 5 is a schematic isometric view of the rangefinder system of FIG. 4 performing measurements; and

FIG. 6 is a vector diagram constructed using measurements performed by the rangefinder system of FIG. 3.

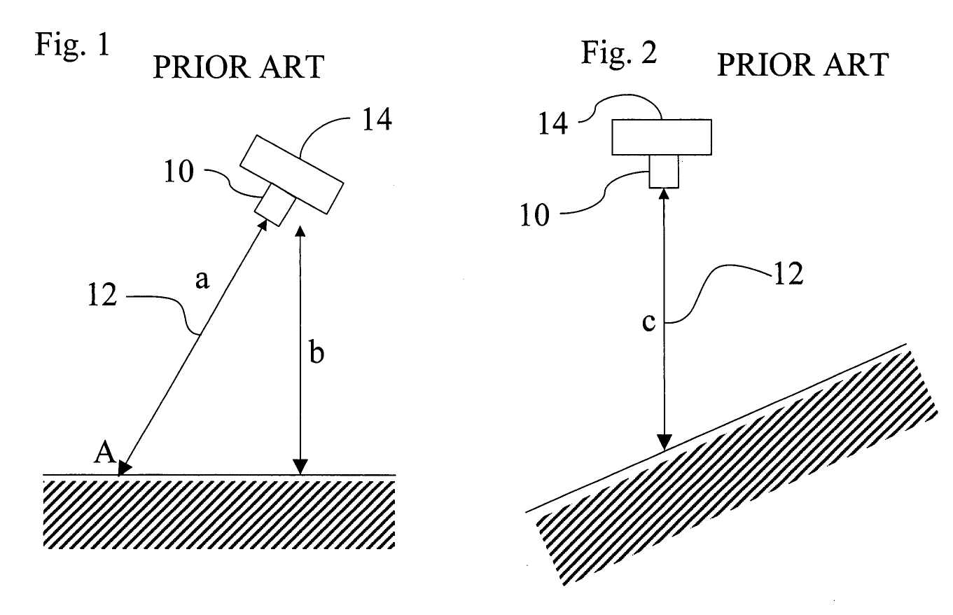

### DESCRIPTION OF THE PREFERRED EMBODIMENTS

The present invention is a multi-beam rangefinder system and method of operation thereof.

The principles and operation of a multi-beam rangefinder system according to the present invention may be better understood with reference to the drawings and the accompanying description.

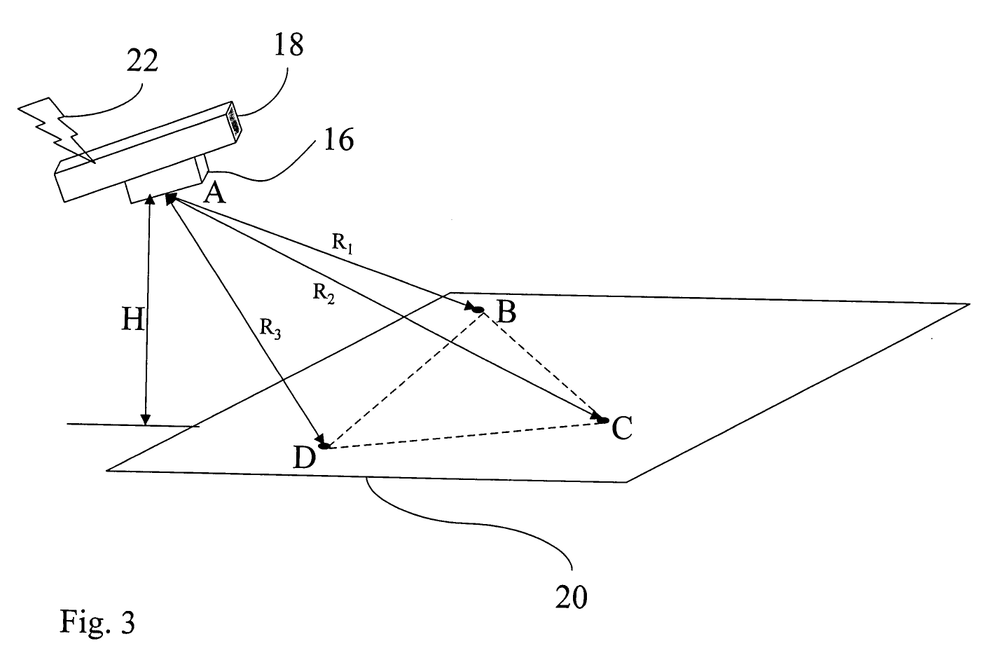

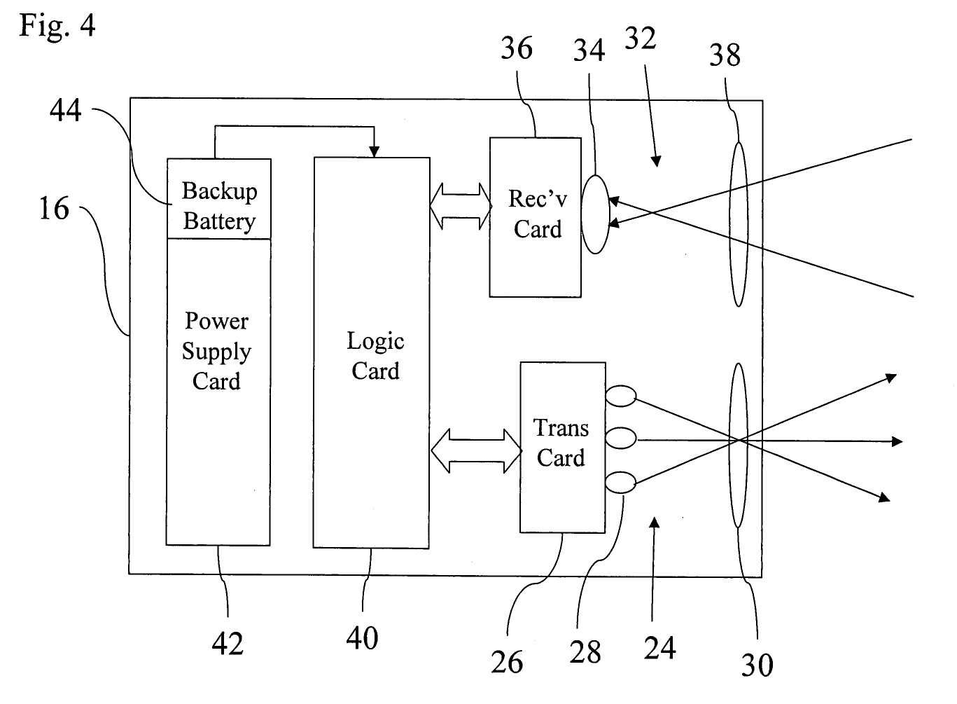

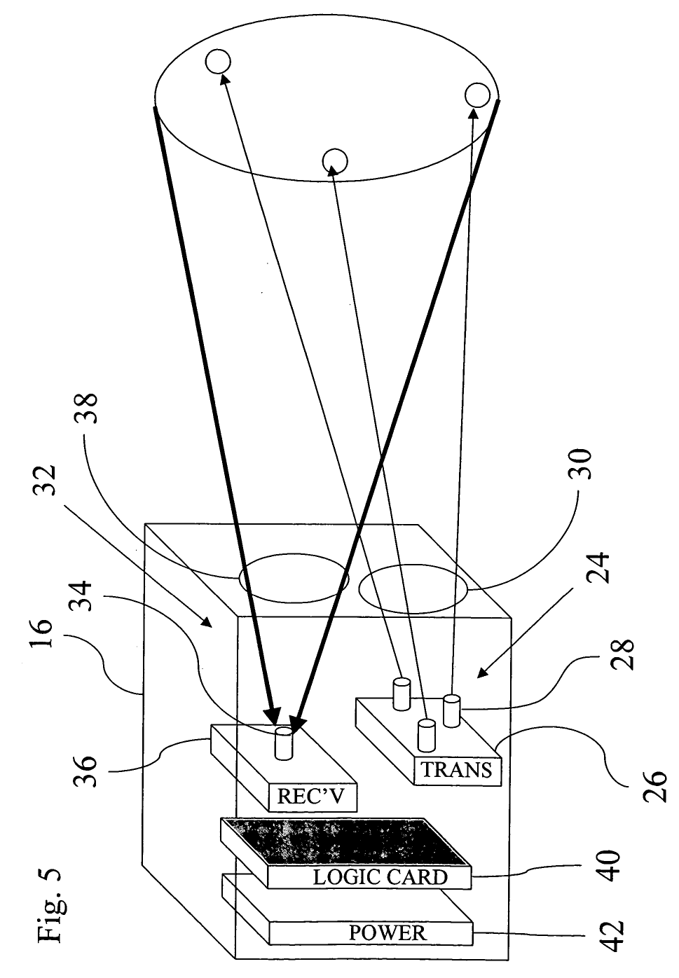

Reference is now made to FIG. 3, which is a schematic view of a multi-beam laser rangefinder system 16 performing measurements that is constructed and operable in accordance with a preferred embodiment of the invention. Multi-beam laser rangefinder system 16 is configured for estimating a range-derived value of an airborne platform 18 relative to the ground 20. Multi-beam laser rangefinder system 16 performs time of flight calculations on directed laser pulses. These time of flights are typically, but not always, used to calculate the distance from the source of the laser pulses to the target of the laser pulses. Therefore, a range-derived value is defined herein as, any value that is determinable from the time of flight of the laser pulses and/or distance measurements performed by multi-beam laser rangefinder system 16. Multi-beam laser rangefinder system 16 estimates range-derived values by the following method. First, multi-beam laser rangefinder system 16 produces a plurality of pulses of electromagnetic radiation directed in three non-coplanar directions. The pulses are produced as non-overlapping pulses directed in the three non-coplanar directions as the pulses are detected by a single sensor, as will be described below with reference to FIGS. 4 and 5. The term “produced as non-overlapping pulses” is defined herein as the pulses are produced one at a time and no two pulses are being produced by multi-beam laser rangefinder system 16 at the same time. Typically, multi-beam laser rangefinder system 16 is configured such that, a new pulse is not produced until an existing pulse has had time to reflect from the ground and be received by multi-beam laser rangefinder system 16. Multi-beam laser rangefinder system 16 is generally configured such that the pulses are produced sequentially in the three non-coplanar directions. For example, one pulse is directed in a first direction, then a second pulse is directed in a second direction and a third pulse is then directed in a third direction. It will be appreciated by those ordinarily skilled in the art that other sequential patterns can be established. The pulses arrive at points B, C, and D on the ground. Points B, C and D define a plane BCD. Therefore, the ground is approximated by a planar model passing through points B, C and D. It will be appreciated by those ordinarily skilled in the art that the number of directions in which the pulses are directed can be increased. One of the advantages in increasing the number of directions is explained later. If more than three directions are used, only three of the directions need to be non-coplanar. For example, if four directions are used, three of the directions can define a plane. The term “in three non-coplanar directions” is defined herein to include more than three directions as long as a minimum of three of the directions chosen are non-coplanar. The pulses are reflected by the ground and received by multi-beam laser rangefinder system 16. Multi-beam laser rangefinder system 16 then processes independent measurements of time of flight of the pulses in each of the three non-coplanar directions in order to estimate range derived values of the airborne platform relative to the ground. The position of multi-beam laser rangefinder system 16 in relation to airborne platform 18 is known. Additionally, the orientation of the non-coplanar directions of the pulses relative to multi-beam laser rangefinder system 16 is known. Therefore, many range-derived values are estimated using the measurements performed by multi-beam laser rangefinder system 16, as will now be explained. It will be appreciated by those ordinarily skilled in the art that as the position of multi-beam laser rangefinder system 16 in relation to airborne platform 18 is known, the range-derived value can be estimated for any point of airborne platform 18. Therefore, the term “range-derived value of an airborne platform relative to the ground” is defined herein as, a range derived value of any point of airborne platform relative to the ground. Additionally, the orientation and position of any point of airborne platform 18 relative to any point on the planar model of the ground is known.

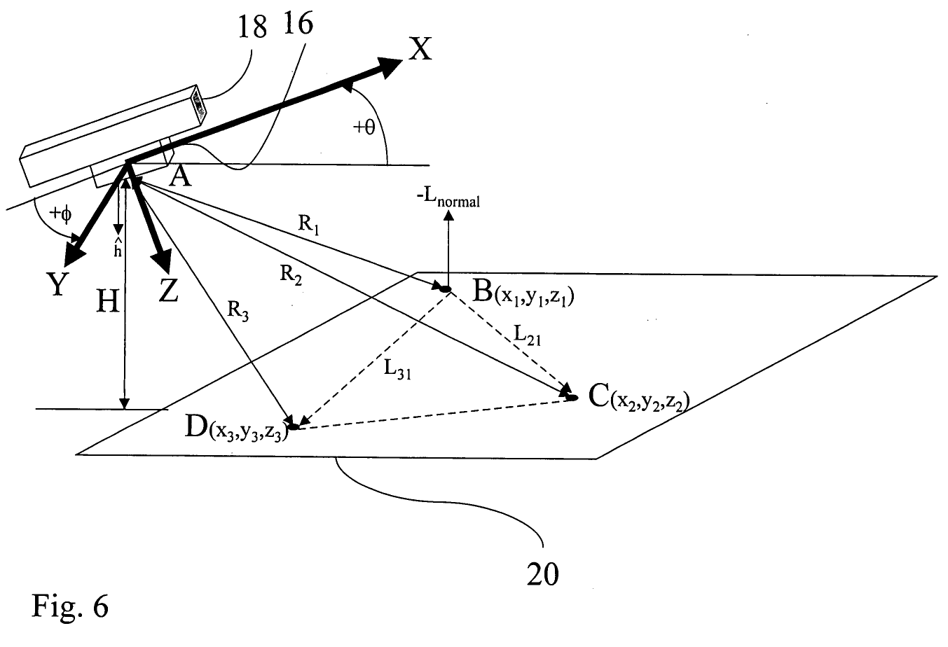

Multi-beam laser rangefinder system 16 processes the time of flight of the pulses in order to derive the distances from point A to points B, C and D, namely, R₁, R₂ and R₃ respectively. As the angles between lines AB, AC and AD are known, the length of a line perpendicular to plane BCD from plane BCD to multi-beam laser rangefinder system 16 is calculated using geometry or vector analysis, giving the altitude, H, of airborne platform 18. Vector analysis of the measurements: performed by multi-beam laser rangefinder system 16 is described in more detail with reference to FIG. 6.

The time derivative of H is calculated to give a rate of descent or ascent of airborne platform 18 relative to the ground. The time derivative of H is calculated using changing values of H over time. The time to hit the ground by airborne platform 18 is calculated, in the case of zero acceleration, by dividing H by the rate of a descent. For the case of non-zero acceleration, the time to hit the ground by airborne platform 18, is calculated by solving a quadratic equation, for example, equation 19 below. The roll and pitch of airborne platform 18 relative to the ground are calculated by performing calculations using R₁, R₂ and R₃. Similarly, the angular velocity and angular acceleration of airborne platform 18 relative to the ground are calculated from time derivatives of the roll and pitch or by performing calculations on the time derivatives of R₁, R₂ and R₃. It will be appreciated by those ordinarily skilled in the art that the above range-derived values can be derived using other analytical and/or mathematical techniques. It will be appreciated by those ordinarily skilled in the art that many other spatial and/or temporal values can be calculated from the measurements performed by multi-beam laser rangefinder system 16. As described above, the number of non-coplanar directions that the pulses are directed in can be increased in order to increase the accuracy of the calculated range-derived values. Three non-coplanar directions is the minimum number required to calculate the range-derived values. If more than three non-coplanar directions are used, the error of the computations is decreased by averaging the results of successive computations derived for each group of three non-coplanar directions.

The estimated range-derived values are used to give a pilot accurate information about the position, orientation and motion of airborne platform 18. The estimated range derived values are also used for autopilot or autolanding of airborne platform 18. Additionally, the estimated range derived values, especially rate of a descent of airborne platform 18 and time-to-hit the ground are used to actuate an emergency system 22 when one or a combination of certain range derived values exceed predefined values. The term “exceed” is herein defined as, going beyond a predefined value either from above or below the predefined value. For example, when the time-to-hit falls below a predefined value, emergency system 22 is actuated and when the rate of descent climbs above a predefined value, emergency system 22 is actuated.

Reference is now made to FIGS. 4 and 5. FIG. 4 is a schematic block view of multi-beam laser rangefinder system 16 of FIG. 3. FIG. 5 is a schematic isometric view of multi-beam laser rangefinder system 16 of FIG. 4 performing measurements. Multi-beam laser rangefinder system 16 includes a transmitter arrangement 24 configured for producing a plurality of pulses of electromagnetic radiation directed in at least three non-coplanar directions. Transmitter arrangement 24 has a transmitter card 26, three laser diodes 28 and an optical arrangement 30. It will be appreciated by those ordinarily skilled in the art that other laser sources can be used instead of laser diodes 28. It will be appreciated by those ordinarily skilled in the art that transmitter arrangement 24 can have more than three laser diodes to increase the number of directions that pulses are directed to, as described above with reference to FIG. 3. Transmitter card 26 manages the operation of laser diodes 28 including the timing of firing of the diodes and the duration of the pulses. For laser diodes employed in ranging applications, the pulse repetition rate is typically in the range of 100 to 10,000 pulses per second and the pulse width is typically in the range of 10 to 50 nanoseconds. Transmitter card 26 is also configured such that, the pulses are non-overlapping pulses as described above with reference to FIG. 3. Transmitter card 26 is also configured for producing the pulses sequentially in the three non-coplanar directions, as described above with reference to FIG. 3. Laser diodes 28 are oriented such that, each laser diode 28 produces a pulse in one of the three non-coplanar directions. Optical arrangement 30 typically includes one or more lenses for focusing the light produced by the laser diodes 28. Multi-beam laser rangefinder system 16 also includes a sensor arrangement 32 for sensing the pulses of electromagnetic radiation reflected from the ground. Sensor arrangement 32 has a single detector 34 for detecting light pulses received from all three non-coplanar directions. Sensor arrangement 32 also includes a receiver card 36 and an optical arrangement 38. Optical arrangement 38 includes one or more lenses. Incoming laser pulses pass through optical arrangement 38 and arrive at detector 34. Detector 34 and optical arrangement 38 in combination, have a field of view which is wide enough, such that detector 34 detects the pulses of all three non-coplanar directions (best seen in FIG. 5). Multi-beam laser rangefinder system 16 also includes a processor arrangement 40. Processor arrangement 40 is configured for calculating the time of flight of the pulses. Processor arrangement 40 manages the timing of the pulses. The timing is reset each time a pulse is produced to insure unambiguous measurement of elapsed time between laser emission and detection. Processor arrangement 40 is also configured for processing the independent measurements of time of flight of the pulses in each of the three non-coplanar directions in order to estimate range derived values of airborne platform 18 relative to the ground. As described with reference to FIG. 3, multi-beam laser rangefinder system 16 is configured to estimate range derived values including, but not limited to, an altitude of airborne platform 18 relative to the ground, a rate of a descent or ascent of airborne platform 18 relative to the ground, a time to hit the ground by airborne platform 18, a roll and pitch of airborne platform 18 relative to the ground and an angular velocity and angular acceleration of airborne platform 18 relative to the ground. Multi-beam laser rangefinder system 16 also includes a power supply 42 and a backup battery 44. It will be appreciated by those ordinarily skilled in the art that components and/or skills used for single-beam laser rangefinders can be used to produce multi-beam laser rangefinder system 16. Many of the components of multi-beam laser rangefinder system 16 depend on the application and the maximum range required. For example, for a range of up to a few hundred meters, semiconductor lasers and detectors are generally suitable. Semiconductor GaAs lasers are commercially available from Perkin-Elmer, Inc. of 44370 Christy Street, Fremont, Calif. 94538-3180, USA and Laser Devices, Inc. of 2 Harris Court, Suite A-4, Monterey, Calif. 93940, USA. Semiconductor Si or InGaAs detectors are commercially available from Perkin Elmer, Inc. and Analog Modules, Inc. of 126 Baywood Avenue Longwood, Fla. 32750-3426, USA. Suitable processors and controllers are commercially available from Analog Devices, Inc. of One Technology Way, P.O. Box 9106, Norwood, Mass. 02062-9106, USA and Texas Instruments, Inc. of 12500 TI Boulevard, Dallas, Tex. 75243-4136, USA.

It will be appreciated by those ordinarily skilled in the art that just as multi-beam laser rangefinder system 16 is constructed with a transmitter arrangement 24 including a plurality of narrow-beam lasers 28 with one wide field of view detector 34, so also a multi-beam laser rangefinder of the present invention can be constructed having a plurality of narrow field-of-view detectors and a single wide divergence laser. In both embodiments, the output is the range along a plurality of non-coplanar directions. The embodiment of multi-beam laser rangefinder system 16 requires less components and is more power efficient and accurate.

Reference is now made to FIG. 6, which is a vector diagram, constructed using measurements performed by multi-beam laser rangefinder system 16 of FIG. 3. Employing a commonly used sign convention, a right-hand coordinate system is attached to airborne platform 18, such that X direction is the forward axis of airborne platform 18, Y direction is perpendicular to X, and Z is perpendicular to X and Y. For i=1 to 3, the directions of the non-coplanar laser beams determined by the securing orientation of laser diodes 28 relative to airborne platform 18, with this order:
χᵢ is the rotation angle relative to axis Z.

βᵢ is the rotation angle relative to axis Y.

The unit vectors for each range measurement are defined as follows:

$${\hat{r}}_{i} = [ \begin{matrix}cos {χ}_{i} \cdot sin {β}_{i} \\ cos {β}_{i} \cdot sin {χ}_{i} \\ - sin {β}_{i}\end{matrix} ] . \qquad ( Equation 1 )$$

Points xᵢ, yᵢ, zᵢ are computed from the ranges Rᵢ, multiplied by the respective unit vectors, as follows:

$${\overline{R}}_{i} = [ \begin{matrix}{x}_{i} \\ {y}_{i} \\ {z}_{i}\end{matrix} ] = Ri \cdot {\hat{r}}_{i} . \qquad ( Equation 2 )$$

Vector L₂₁ is computed as follows:
\overline{L}₂₁=\overline{R}₂−\overline{R}₁ (Equation 3).

Vector L₃₁ is computed as follows:
\overline{L}₃₁=\overline{R}₃−\overline{R}₁ (Equation 4).

Employing vector multiplication, vector Lₙₒᵣₘₐₗ computed as follows:
\overline{L}ₙₒᵣₘₐₗ=\overline{L}₂₁×\overline{L}₃₁ (Equation 5).

For the three projections of vector Lₙₒᵣₘₐₗ(L_{normal/x}, L_{normal/y}, L_{normal/z}), the unit vector ĥ is computed as follows:

$$\hat{h} = \frac{{\overline{L}}_{normal}}{\sqrt{{L}_{normal / x}^{2} + {L}_{normal / y}^{2} + {L}_{normal / z}^{2}}} \qquad ( Equation 6 )$$

Employing scalar multiplication, the perpendicular height H above ground 20 is computed from one of equations 7, 8 or 9 (improved accuracy may be achieved by averaging the alternate results):
H=ĥ·\overline{R}₁ (Equation 7)
or
H=ĥ·\overline{R}₂ (Equation 8)
or
H=ĥ·\overline{R}₃ (Equation 9)

For the three projections of the unit vector ĥ(hₓ, h_{y}, h_{z}), the pitch angle θ of airborne platform 18 is computed as follows (atan is the inverse of the trigonometric function tangent, sometimes denoted as tan⁻¹ or tg⁻¹):

$${θ}_{pitch} = a tan [ \frac{- {h}_{x}}{\sqrt{{h}_{y}^{2} + {h}_{z}^{2}}} ] . \qquad ( Equation 10 )$$

The roll angle Φ of airborne platform 18 is computed as follows:

$${ϕ}_{roll} = a tan [ \frac{{h}_{y}}{{h}_{z}} ] . \qquad ( Equation 11 )$$

The angular velocity of the pitch angle and roll angle, respectively, is computed as follows:

$$\begin{matrix}{ω}_{pitch} = \frac{ⅆ ( {θ}_{pitch} )}{ⅆ t} & ( Equation 12 ) \\ {ω}_{roll} = \frac{ⅆ ( {ϕ}_{roll} )}{ⅆ t} . & ( Equation 13 )\end{matrix}$$

The angular acceleration of the pitch angle and roll angle, respectively, is computed as follows:

$$\begin{matrix}{α}_{pitch} = \frac{ⅆ ( {ω}_{pitch} )}{ⅆ t} & ( Equation 14 ) \\ {α}_{roll} = \frac{ⅆ ( {ω}_{roll} )}{ⅆ t} . & ( Equation 15 )\end{matrix}$$

The rate of descent or ascent is computed as follows:

$${rate}_{descent} = \frac{ⅆ ( H )}{ⅆ t} . \qquad ( Equation 16 )$$

The acceleration of the platform relative to the ground is computed as follows:

$$accel = \frac{ⅆ ( {rate}_{descent} )}{ⅆ t} . \qquad ( Equation 17 )$$

The time to hit the ground in the case of zero acceleration is computed as follows:

$$Time = \frac{H}{{rate}_{descent}} . \qquad ( Equation 18 )$$

The time to hit the ground in the case of nonzero acceleration is computed as follows:

$$Time = \frac{- {rate}_{descent} + \sqrt{{rate}_{descent}^{2} + 2 \cdot accel \cdot H}}{accel} . \qquad ( Equation 19 )$$

Filtering techniques may be applied to the measurements to improve the accuracy of the computed values.

It will be appreciated by persons skilled in the art that the present invention is not limited to what has been particularly shown and described hereinabove. Rather, the scope of the present invention includes both combinations and sub-combinations of the various features described hereinabove, as well as variations and modifications thereof that are not in the prior art which would occur to persons skilled in the art upon reading the foregoing description.

1. A multi-beam rangefinder system for estimating a range-derived value of an airborne platform relative to the ground, the ground being approximated by a planar model, the system comprising:
(a) a transmitter arrangement configured for producing a plurality of pulses of electromagnetic radiation directed in at least three non-coplanar directions;
(b) a sensor arrangement for sensing said pulses of electromagnetic radiation reflected from the ground; and
(c) a processor arrangement configured for processing of independent measurements of time of flight of said pulses in each of said three non-coplanar directions in order to estimate the range derived value of the airborne platform relative to the ground.

2. The system of claim 1, wherein said transmitter arrangement is configured such that said pulses are produced as non-overlapping pulses.

3. The system of claim 2, wherein said transmitter arrangement is configured for producing said pulses sequentially in said three non-coplanar directions.

4. The system of claim 1 wherein said processor is configured for processing of independent measurements of time of flight of said pulses in each of said three non-coplanar directions in order to estimate an altitude of the airborne platform relative to the ground.

5. The system of claim 1 wherein said processor is configured for processing of independent measurements of time of flight of said pulses in each of said three non-coplanar directions in order to estimate a rate of a descent or ascent of the airborne platform relative to the ground.

6. The system of claim 1 wherein said processor is configured for processing of independent measurements of time of flight of said pulses in each of said three non-coplanar directions in order to estimate a rate of an acceleration of the airborne platform relative to the ground.

7. The system of claim 1 wherein said processor is configured for processing of independent measurements of time of flight of said pulses in each of said three non-coplanar directions in order to estimate a time to hit the ground by the airborne platform.

8. The system of claim 1 wherein said processor is configured for processing of independent measurements of time of flight of said pulses in each of said three non-coplanar directions in order to estimate a roll of the airborne platform relative to the ground.

9. The system of claim 1 wherein said processor is configured for processing of independent measurements of time of flight of said pulses in each of said three non-coplanar directions in order to estimate a pitch of the airborne platform relative to the ground.

10. The system of claim 1 wherein said processor is configured for processing of independent measurements of time of flight of said pulses in each of said three non-coplanar directions in order to estimate an angular velocity of the airborne platform relative to the ground.

11. The system of claim 1 wherein said processor is configured for processing of independent measurements of time of flight of said pulses in each of said three non-coplanar directions in order to estimate an angular acceleration of the airborne platform relative to the ground.

12. The system of claim 1, wherein said sensor arrangement includes a single detector, said sensor arrangement having a field of view which is wide enough, such that said single detector detects said pulses of all of said at least three non-coplanar directions.

13. The system of claim 1, further comprising an emergency system configured for being actuated in response to the range derived value exceeding a predefined value.

14. The system of claim 13, wherein said predefined value is a rate of a descent or ascent of the airborne platform relative to the ground.

15. The system of claim 13, wherein said predefined value is a time to hit the ground by the airborne platform.

16. A method for estimating a range-derived value of an airborne platform relative to the ground, the ground being approximated by a planar model, the method comprising the steps of:
(a) producing a plurality of pulses of electromagnetic radiation directed in three non-coplanar directions;
(b) receiving said pulses of electromagnetic radiation reflected from the ground; and
(c) processing independent measurements of time of flight of said pulses in each of said three non-coplanar directions in order to estimate the range derived value of the airborne platform relative to the ground.

17. The method of claim 16, wherein said range defined value is a rate of a descent or ascent of the airborne platform relative to the ground.

18. The method of claim 16, wherein said range defined value is a time to hit the ground by the airborne platform.

19. The method of claim 16, wherein said range defined value is a roll of the airborne platform relative to the ground.

20. The method of claim 16, wherein said range defined value is a pitch of the airborne platform relative to the ground.

21. The method of claim 16, wherein said range defined value is an angular velocity of the airborne platform relative to the ground.

22. The method of claim 16, wherein said range defined value is an angular acceleration of the airborne platform relative to the ground.

23. The method of claim 16, wherein said range defined value is a rate of a descent or ascent of the airborne platform relative to the ground.

24. The method of claim 16, wherein said range defined value is an acceleration of the airborne platform relative to the ground.

25. The method of claim 16, wherein said step of producing is performed by producing said pulses as non-overlapping pulses directed in three non-coplanar directions.

26. The method of claim 25, wherein said step of producing is performed by producing said pulses sequentially in said three non-coplanar directions.

27. The method of claim 16, further comprising the step of actuating an emergency system in response to the range derived value exceeding a predefined value.

28. The method of claim 27, wherein said predefined value is a rate of a descent or ascent of the airborne platform relative to the ground.

29. The method of claim 27, wherein said predefined value is a time to hit the ground by the airborne platform.
